(19) United States
(12) Patent Application Publication
(10) Pub. No.: US 2005/0187318 A1
(43) Pub. Date: Aug. 25, 2005

(54) Polyolefin resin composition

(75) Inventor: Kenji Kimura, Toyonaka-shi (JP)

Correspondence Address: FOLEY AND LARDNER;SUITE 500, 3000 K STREET NW, WASHINGTON, DC, 20007, US

(73) Assignee: SUMITOMO CHEMICAL COMPANY, LIMITED

(21) Appl. No.: 11/059,325

(22) Filed: Feb. 17, 2005

(30) Foreign Application Priority Data
Feb. 20, 2004 (JP) 2004-044779

(51) Int. Cl. C08K 5/46; C08K 5/15; C08K 5/48

(52) U.S. Cl. 524/83; 524/108; 524/115

(57) ABSTRACT

There are disclosed a polyolefin resin composition, comprising (A) a polyolefin resin,
(B) an anti-oxidant of formula (B-I): 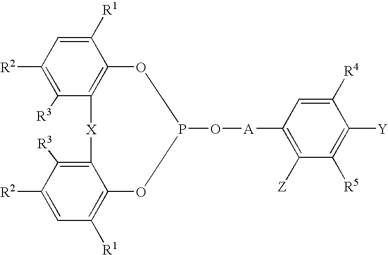
wherein R¹, R², R⁴ and R⁵ independently represent hydrogen, C₁₋₈ alkyl, or the like, R³ represents hydrogen, C₁₋₈ alkyl, or the like, X represents a single bond, sulfur atom, or the like, A represents C₂₋₈ alkylene, or the like, and (C) at least one phosphorous type anti-oxidant selected from the group consisting of compounds of formula (C-I), formula(C-II), formula (C-III) and formula (C-IV), and wherein the weight ratio of (C) to (B) is 1:3 to 10:1, and the amount of (B) and (C) each is 0.001 to 1 part by weight per 100 parts by weight of the polyolefin (A).

### FIELD OF THE INVENTION

The present invention relates to a polyolefin resin composition.

### BACKGROUND OF THE INVENTION

Polyolefin resins have versatile utility as the materials for packaging, unwoven fabrics, container, automobile or home electric appliances because of their good appearances, mechanical strength, anti-chemical properties, or suitability for packaging, and are typically melt-kneaded at about 150 to 300° C. by using an extruder to form pellets, and then they were processed into various articles. JP 11-222493A discloses in Example 2, column 37 a composition containing polypropylene (block co-polymer), 2,4,8,10-tetra-t-butyl-6-[3-(3-methyl-4-hydroxy-5-t-butylphenyl)propoxy]-dibenz[d,f][1,3,2]dioxaphosphepin and tris(2,4-di-t-butylphenyl)-phosphonite and that such resin composition has good melt flow property, which is referred to as processing stability.

### DETAILED DESCRIPTION OF THE INVENTION

Polyolefin resin compositions or the articles processed therefrom according to the present invention show not only better processing stability but also better color stability when processed, which is referred to as resistance to thermal discoloring, in a balanced manner.

An aspect of the invention relates to polyolefin resin composition, comprising

(A) a polyolefin resin,

(B) an anti-oxidant of formula (B-I):

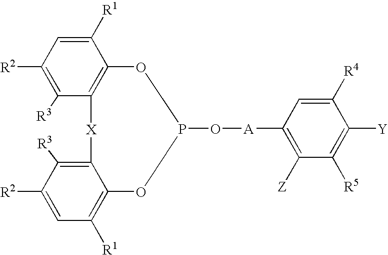

wherein R¹, R², R⁴ and R⁵ independently represent hydrogen, C₁₋₈ alkyl, C₅₋₈ cycloalkyl, C₆₋₁₂ alkylcycloalkyl, C₇₋₁₂ aralkyl, or phenyl,
R³ represents hydrogen, C₁₋₈ alkyl,
X represents a single bond, sulfur atom, or —CHR⁶—, wherein R⁶ represents hydrogen, C₁₋₈ alkyl, or C₅₋₈ cycloalkyl,
A represents C₂₋₈ alkylene, or a group of formula:

*—COR⁷—, wherein R₇ represents a single bond or C₁₋₈ alkylene, and the bond indicated by * means that said bond is connected with the phosphite oxygen atom in formula (B-I),

either one group of Y and Z represents hydroxyl group, C₁₋₈ alkoxy, or C₇₋₁₂ aralkyloxy, and the other group represents hydrogen or C₁₋₈ alkyl, and

provided that when Y is hydroxyl one of R⁴ and R5 represents C3-8 alkyl, C₅₋₈ cycloalkyl, C₆₋₁₂ alkylcycloalkyl, C₇₋₁₂ aralkyl or phenyl, and

two R¹ groups, two R² group and two R³ groups each may be the same or different, and

(C) at least one phosphorous type anti-oxidant selected from the group consisting of:

a compound of formula (C-I):

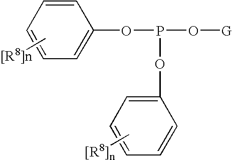

wherein R⁸ represents C₁₋₈ alkyl, C₅₋₈ cycloalkyl, C₆₋₁₂ alkylcycloalkyl, C₇₋₁₂ aralkyl, or phenyl,

G represents C₁₋₈ alkyl, C₇₋₁₂ aralkyl, or phenyl and

n is an integer of 1 to 3, provided that two n may be the same or different,

a compound of formula (C-II):

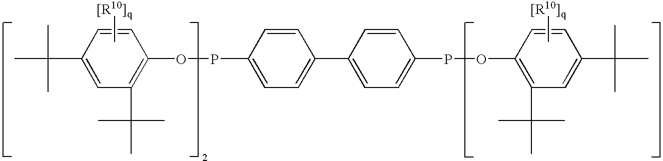

wherein q independently represents an integer of 0 or 1, and R¹⁰ independently represents methyl,

a compound of formula (C-III):

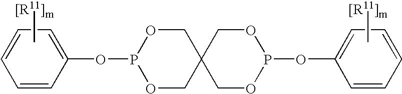

wherein m independently represents an integer of 1 to 3, and

R¹¹ groups are the same or different and independently represent C₁₋₈ alkyl, C₅₋₈ cycloalkyl, C₆₋₁₂ alkylcycloalkyl, C₇₋₁₂ aralkyl, or phenyl, and

a compound of formula (C-IV):

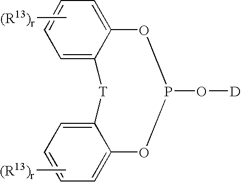

wherein R¹³ groups are the same or different and each independently represents C₁₋₈ alkyl, C₅₋₈ cycloalkyl, C₆₋₁₂ alkylcycloalkyl, C₇₋₁₂ aralkyl, or phenyl,
T represents a single bond, sulfur, or a divalent group of formula —CHR¹⁶—, wherein R¹⁶ represents hydrogen, C₁₋₈ alkyl, or C₅₋₈ cycloalkyl,
D represents C₁₋₈ alkyl, C₇₋₁₂ aralkyl, or phenyl, and
r independently represents an integer of 0 to 3, and wherein the weight ratio of (C) to (B) is 1:3 to 10:1, and the amount of (B) and (C) each is 0.001 to 1 part by weight per 100 parts by weight of the polyolefin resin (A).

Another aspect of the invention relates to a process for producing the polyolefin resin composition defined above, which comprises mixing

the phosphorous type antioxidant compound (C),

the anti-oxidant compound (B), and

the polyolefin resin (A),

wherein the weight ratio of (C) to (B) is 1:3 to 10:1, and the amount of (B) and (C) each is 0.001 to 1 part by weight per 100 parts by weight of the polyolefin resin (A), and

melt-kneading the resulting mixture.

Examples of the polyolefin resin include, for example,

(1) polyethylene, for example, high-density polyethylene (HD-PE), low-density polyethylene (LD-PE) and linear low-density polyethylene (LLDPE)

(2) polypropylene

(3) methylpentene polymer

(4) EEA (ethylene/ethyl acrylate copolymer) resin

(5) ethylene/vinyl acetate copolymer resin

(6) ethylene/propylene co-polymer

(7) ethylene/vinyl acetate copolymer, and

(8) cyclic polyolefin.

Preferred polyolefin is homo-polypropylene, hereinafter referred to as A1, polypropylene(co-polymer) obtained by block copolymerization, and polypropylene (co-polymer or terpolymer) obtained by random co-polymerization,

The polyolefins are not specifically limited. For example, they may be those obtained by radical polymerization or those produced by the polymerization using a catalyst containing a metal of Group IVb, Vb, VIb or VIII of the Periodic Table.

The catalyst containing such a metal may be a metal complex comprising one or more coordinated ligands such as oxides which are coordinated by a π- or σ-bond, halogenated compounds, alcoholates, esters, an aryl group or the like, and the complex may be used as it is, or the complexes may be carried by a base material such as magnesium chloride, titanium chloride, alumina, silicon oxide, etc.

As the polyolefin, for example, preferably used are those produced by using Ziegler-Natta catalyst, metallocene catalyst, Phillips catalyst and the like.

In the anti-oxidant compound of formula (B-I),

R₁ and R₂ are preferably C₁₋₈ alkyl, C₅₋₈ cycloalkyl, or C₆₋₁₂ alkylcycloalkyl.

R₄ is preferably i-propyl, I-butyl, sec-butyl, t-butyl, t-pentyl, i-octyl, t-octyl, cyclohexyl, 1-methylcyclohexyl or 2-ethylhexyl.

R₅ is preferably hydrogen, or C₁₋₅ alkyl such as methyl, ethyl, n-propyl, i-propyl, n-butyl, i-butyl, sec-butyl, t-butyl or t-pentyl.

R₃ is preferably hydrogen or C₁₋₅ alkyl such as methyl, ethyl, n-propyl, i-propyl, n-butyl, i-butyl, sec-butyl, t-butyl or t-pentyl.

X is preferably a single bond, sulfur, or methylene.

A is preferably propylene, *—CO—, or *—COCH₂CH₂—, wherein * menas that the —CO— group is bonded with the oxygen atom of the phosphite oxygen atom.

Y is preferably hydroxyl group.

Z is preferably hydrogen or C₁₋₈ alkyl.

Also preferred are optional combinations among the preferred features above.

Preferred examples of the anti-oxidant of formula (B-I) are
6-[3-(3-t-butyl-4-hydroxy-5-methylphenyl)propoxy]-2,4,8,10-tetra-t-butyl-dibenz[d,f][1,3,2]dioxaphosphepin, hereinafter referred to as B1,
6-[3-(3,5-di-t-butyl-4-hydroxyphenyl)propoxy]-2,4,8,10-tetra-t-butyldi-benz[d,f][1,3,2]dioxaphosphepin,
6-[3-(3,5-di-t-butyl-4-hydroxyphenyl)propoxy]-4,8-di-t-butyl-2,10-dimethyl-12H-dibenz[d,g][1,3,2]dioxaphosphocin, and
6-[3-(3,5-di-t-butyl-4-hydroxyphenyl)propionyloxy]-4,8-di-t-butyl-2,10-dimethyl-12H-dibenz[d,g][1,3,2]dioxaphosphocin.

Preferred examples of the anti-oxidant of formula (C) are bis(2,4-di-t-butylphenyl) pentaerythrytyl diphosphite, hereinafter referred to as C1,
tetrakis(2,4-di-t-butyl-4-methylphenyl)-4,4′-biphenylene-diphosphonite, hereinafter referred to as C2,
bis(2,4-di-t-butyl-4-methylphenyl)pentaerythrytyl diphosphite, hereinafter referred to as C3,
bis(2,4-di-t-butyl-6-methylphenyl)ethyl phosphite, hereinafter referred to as C4,
tetrakis(2,4-di-t-butyl-5-methylphenyl)-4,4′-biphenylene-diphosphonite, hereinafter referred to as C5,
bis(2,4-di-cumylphenyl)pentaerythrytyl diphosphite, hereinafter referred to as C6, and
2,4,8,10-tetra-t-butyl-6-(2-ethylhexyloxy)-12H-dibenz[d,g][1,3,2]dioxa-phosphocin, hereinafter referred to as C7.

The polyolefin resin composition of the invention is typically prepared by the steps of mixing the polyolefin resin (A), the phosphorous type anti-oxidant of formula (B-I), antioxidant selected from the group consisting of anti-oxidants of formula (C-I), (C-II), (C-III) and (C-IV) in the weight amount ratio as defined above, and melt-kneading the resulting mixture.

Preferably, 0.01 to 0.5 part by weight of the compound of formula (B-I) is used per 100 parts by weight of polyolefin, and still more preferably 0.05 to 0.2 part by weight of the compound of formula (B-I) is used per 100 parts by weight of polyolefin resin (A). More than 1 part by weight of the antioxidant of formula (B-I) per 100 parts by weight of the polyolefin resin (A) is not so advantageous for the present composition in view of its efficacy and economy.

Preferably, 0.01 to 0.5 part by weight of the compound of formula (C) is used per 100 parts by weight of polyolefin, and still more preferably 0.05 to 0.2 part by weight of the compound of formula (B-I) is used per 100 parts by weight of polyolefin.

Desirable balancing of processing stability and resistance to thermal discoloration is realized by using the prescribed amounts of the components and amount ratios between them as defined above.

The polyolefin resin composition may comprise further agent(s), for example, at least one agent selected from the group consisting of other antioxidant agents other than (B) and (C), organic peroxides, anti-blocking agents, light-stabilizers, lubricants, anti-static agents, and pigments, if necessary.

The organic peroxide may be added to improve the melt flow property MI of the resin composition within a more preferred range.

Examples of the organic peroxide include, for example, peroxy alkyl such as dicumyl peroxide, di-t-butyl peroxide, di-t-butylcumyl peroxide, 2,5-dimethyl-2,5-di(tert-butylperoxy)hexane, 2,5-dimethyl-2,5-di(benzoylperoxy)hexene, 1,3-bis(t-butylperoxiyisopropyl)benzene, or 3,6,9-triethyl-3,6,9-trimethyl-1,4,7-triperoxynonane;
diacyl peroxide such as benzoyl peroxide, lauroyl peroxide, decanoyl peroxide or the like;
peroxy esters such as 1,1,3,3-tetramethylbutylperoxy neodecanoate, t-butyl peroxyneodecanoate, a-cumyl peroxyneodecanoate, t-butyl peroxyneoheptanoate, t-butyl peroxypivalate, t-hexyl peroxypivalate, 1,1,3,3-tetramethylbutyl peroxy-2-ethylhexanoate, t-amy peroxy-2-ethylhexanoate, t-butyl peroxyisobutyrate, di-t-butyl peroxyhexahydroterephthalate, t-amyl peroxy-3,5,5-trimethylhexanoate, t-butyl peroxyacetate, t-butyl peroxybenzoate, di-t-butyl peroxytrimethyladipate, or the like;
peroxy carbonate such as di-3-methoxybutyl peroxydicarbonate, di(2-ethylhexyl)peroxydicarbonate, diisopropyl peroxydicarbonate, diisopropyl peroxycarbonate, di(4-t-butylcyclohexyl)peroxydicarbonate, dicetyl peroxydicarbonate, dimyristyl peroxydicarbonate or the like.

Preferred is peroxyalkyl. Among the peroxyalkyl, particularly preferred are 2,5-dimethyl-2,5-di(t-butylperoxy)hexane, hereinafter referred to as D1, 1,3-bis(t-butylperoxyisopropyl)benzene and 3,6,9-triethyl-3,6,9-trimethyl- 1,4-7-triperoxynonane.

The organic peroxide is preferably blended with 100 parts by weight of the polyolefin resin (A) in the amount of 0.0001 to 0.5 part by weight, more preferably in the amount of 0.0005 to 0.3 part, and yet more preferably in the amount of 0.001 to 0.1 part by weight.

The composition of the present invention which further comprises the organic peroxide shows more improved processing stability and resistance to thermal discoloration and in a manner both properties are balanced contrary to the general tendency of inferior processing stability and resistance to thermal discoloration that may be caused by the addition of organic peroxides.

The organic peroxide may be added to polyolefin resin (A) in a suitable amount or a master batch prepared from the polyolefin resin (A) powder and the organic peroxide in a higher amount, by impregnating the latter in the former, may be suitably diluted with the polyolefin. The amount of the organic peroxide impregnated in the polyolefin is preferably 1 to 20 wt %.

These additional agent or agents may be uniformly mixed with the components (A) to (C) by a mixer such as Henschel-mixer or Super-mixer, and then melt-kneaded by a mono-axis, or multi-axis extruder or by melt-kneaded by a kneader, or a Bambury mixer and then granulated or palletized by an extruder. The granulated or palletized products are processed into film by a membrane forming machine or to fiber by a forming winder or processed into molded articles by an injection molder.

### EXAMPLE

The present invention is explained further in detail by way of Examples, but is not construed to limit the invention thereto.
A1: Homo-polypropylene
B1: 6-[3-(3-t-butyl-4-hydroxy-5-methylphenyl)propoxy]-2,4,8,10-tetra-t-butyldibenz[d,f][1,3,2]dioxaphosphepin
C1: bis(2,4-di-t-butylphenyl)pentaerythrytyl diphosphite
C2: tetrakis(2,4-di-t-butyl-4-methylphenyl)-4,4′-biphenylene-diphospho-nite,
C3: bis(2,4-di-t-butyl-4-methylphenyl)pentaerythrytyl diphosphite
C4: bis(2,4-di-t-butyl-6-methylphenyl)ethyl phosphite,
C5: tetrakis(2,4-di-t-butyl-5-methylphenyl)-4,4′-biphenylene-diphospho-nite
C6: bis(2,4-di-cumylphenyl)pentaerythrytyl diphosphite
C7: 2,4,8,10-tetra-t-butyl-6-(2-ethylhexyloxy)-12H-dibenz[d,g][1,3,2]-dioxaphosphocin
D1: 2,5-dimethyl-2,5-di(t-butylperoxy) hexane
AO1: pentarythrytyl tetrakis(3-3(3,5-di-t-butyl-4-hydroxyphenyl)-propionate
AO2: tris(2,4-di-t-butylphenyl)phosphite

### Example 1

### Preparation of Polypropylene Resin Composition

100 parts by weight of polypropylene homopolyer with MI: 20, 0.05 part by weight of calcium stearate, 0.1 part by weight of B1, and 0.1 part by weight of C1 were dry-blended, and the resulting mixture was heated and melt-kneaded with a 30 mmφ mono-axis extruder at 250° C. to produce pellets, which is referred to as Compound pellets.

The compound pellets were extruded four times with the same extruder used above under the same condition as used above except that the temperature was changed to 270° C., and then the obtained pellets were processed into a sheet of 40 mm×60 mm×1 mm by an injection-molder.

Processing stability was evaluated in terms of ΔMI, which is the difference between the melt flow index value MI of the resin composition after extruded four times, which is referred to as MI₄, and that of the compounded pellets obtained after extruding the dry-blended mixture containing the resin and various additives, which is referred to as MI_{c}.

Resistance to thermal discoloration was evaluated in terms of ΔYI, which is the difference between the resistance to thermal discoloration represented by YI of the sheet obtained through an injection-molder after four times of extruding, which is referred to as YI₄ and that of a sheet obtained from the compounded pellets by an injection-molder, which is referred to as YI_{c}.

### Example 2 to 9 and Comparative Example 1 to 3

Compound pellets and sheets were prepared in a similar manner as In Example 1 by using each additive AO1 and AO2 listed below.

TABLE 1

| | | | Other | | |
|---|---|---|---|---|---|
| Example | (B) (%) | (C) (%) | additive (%) | ΔMI | ΔYI |
| 1 | B1/0.1 | C1/0.1 | None | 6.82 | 0.31 |
| 2 | B1/0.1 | C2/0.1 | None | 6.46 | 0.23 |
| 3 | B1/0.1 | C3/0.1 | None | 5.95 | 0.45 |
| 4 | B1/0.1 | C4/0.1 | None | 7.15 | 0.65 |
| 5 | B1/0.1 | C5/0.1 | None | 7.25 | 0.38 |
| 6 | B1/0.1 | C6/0.1 | None | 6.81 | 0.54 |
| 7 | B1/0.1 | C7/0.1 | None | 6.72 | 0.59 |
| 8 | B1/0.15 | C1/0.15 | None | 5.38 | 0.38 |
| 9 | B1/0.06 | C2/0.06 | None | 7.45 | 0.40 |

TABLE 2

| Comparative | | | Other | | |
|---|---|---|---|---|---|
| Example | (B) (%) | (C) (%) | additive (%) | ΔMI | ΔYI |
| 1 | B1/0.1 | None | AO1/0.1 | 6.30 | 0.88 |
| 2 | B1/0.1 | None | AO2/0.1 | 8.37 | 0.81 |
| 3 | B1/0.025 | C2/0.1 | None | 9.39 | 0.17 |

### Example 10 to 12 and Comparative Example 4 to 6

In Example 10 compound pellets and sheet were prepared in a similar manner as in Example 1 except that polypropylene homopolymer prepared by adding 0.25 part by weight of polypropylene containing 8 wt % of D1, which contains D1 at a concentration of 0.02 wt %.

In Examples 11 and 12 and Comparative Examples 4 to 6, compound and sheet were prepared in a similar manner as in Example

TABLE 3

| | | | Other | | |
|---|---|---|---|---|---|
| Example | (B) (%) | (C) (%) | additive (%) | ΔMI | ΔYI |
| 10 | B1/0.06 | C1/0.06 | D1/0.02 | 10.73 | 0.42 |
| 11 | B1/0.1 | C1/0.15 | D1/0.02 | 11.94 | 0.46 |
| 12 | B1/0.1 | C1/0.15 | D1/0.032 | 15.39 | 0.39 |

TABLE 4

| Comparative | | | Other | | |
|---|---|---|---|---|---|
| Example | (B) (%) | (C) (%) | additive (%) | ΔMI | ΔYI |
| 4 | B1/0.025 | C2/0.1 | D1/0.02 | 20.11 | 0.18 |
| 5 | B1/0.06 | None | D1/0.02, | 16.59 | 0.61 |
| | | | AO2/0.06 | | |
| 6 | B1/0.12 | None | D1/0.02 | 11.52 | 0.75 |

1. A polyolefin resin composition, comprising
(A) a polyolefin resin,
(B) an anti-oxidant of formula (B-I): 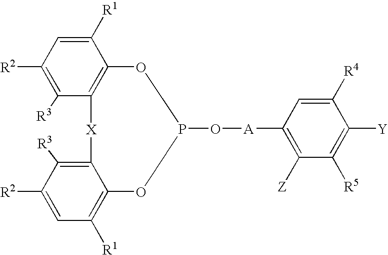
wherein R¹, R², R⁴ and R5 independently represent hydrogen, C₁₋₈ alkyl, C₅₋₈ cycloalkyl, C₆₋₁₂ alkylcycloalkyl, C₇₋₁₂ aralkyl, or phenyl,
R³ represents hydrogen, C₁₋₈ alkyl,
X represents a single bond, sulfur atom, or —CHR⁶—, wherein R⁶ represents hydrogen, C₁₋₈ alkyl, or C₅₋₈ cycloalkyl,
A represents C₂₋₈ alkylene, or a group of formula:
*—COR⁷—, wherein R⁷ represents a single bond or C₁₋₈ alkylene, and the bond indicated by * means that said bond is connected with the oxygen atom of the phosphite of formula (II),
either one group of Y and Z represents hydroxyl group, C₁₋₈ alkoxy, or C₇₋₁₂ aralkyloxy, and the other group represents hydrogen or C₁₋₈ alkyl, and
provided that when Y is hydroxyl one of R⁴ and R⁵ represents C₃₋₈ alkyl, C₅₋₈ cycloalkyl, C₆₋₁₂ alkylcycloalkyl, C₇₋₁₂ aralkyl or phenyl, and
two R¹ groups, two R² group and two R³ groups each may be the same or different, and
(C) at least one phosphorous type anti-oxidant selected from the group consisting of:
a compound of formula (C-I): 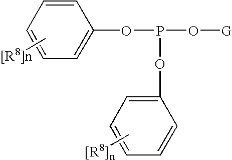
wherein R⁸ represents C₁₋₈ alkyl, C₅₋₈ cycloalkyl, C₆₋₁₂ alkylcycloalkyl, C₇₋₁₂ aralkyl, or phenyl,
G represents C₁₋₈ alkyl, C₇₋₁₂ aralkyl, or phenyl and
n is an integer of 1 to 3, provided that two n may be the same or different,
a compound of formula (C-II): 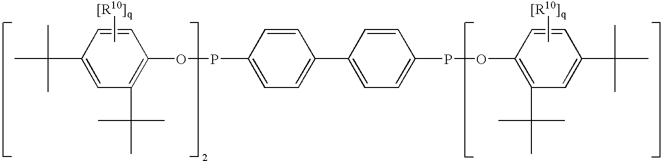
wherein q independently represents an integer of 0 or 1, and R¹⁰ independently represents methyl,
a compound of formula (C-III): 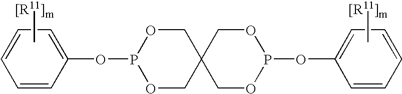
wherein m independently represents an integer of 1 to 3, and
R¹¹ groups are the same or different and independently represent C₁₋₈ alkyl, C₅₋₈ cycloalkyl, C₆₋₁₂ alkylcycloalkyl, C₇₋₁₂ aralkyl, or phenyl, and
a compound of formula (C-IV): 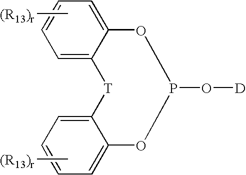
wherein R¹³ groups are the same or different and each independently represents C₁₋₈ alkyl, C₅₋₈ cycloalkyl, C₆₋₁₂ alkylcycloalkyl, C₇₋₁₂ aralkyl, or phenyl,
T represents a single bond, sulfur, or a divalent group of formula —CHR¹⁶—, wherein R¹⁶ represents hydrogen, C₁₋₈ alkyl, or C₅₋₈ cycloalkyl,
D represents C₁₋₈ alkyl, C₇₋₁₂ aralkyl, or phenyl, and
r independently represents an integer of 0 to 3, and wherein the weight ratio of (C) to (B) is 1:3 to 10:1, and the amount of (B) and (C) each is 0.001 to 1 part by weight per 100 parts by weight of the polyolefin resin (A).

2. A polyolefin resin composition according to claim 1, which further comprises an organic peroxide in an amount of 0.0001 to 0.5 part by weight per 100 parts by weight of the polyolefin resin (A).

3. A process for producing the polyolefin resin composition of claim 1, which comprises mixing
the phosphorous type antioxidant compound (C),
the anti-oxidant compound (B), and
the polyolefin resin (A),
wherein the weight ratio of (C) to (B) is 1:3 to 10:1, and the amount of (B) and (C) each is 0.001 to 1 part by weight per 100 parts by weight of the polyolefin resin (A), and
melt-kneading the resulting mixture.

4. A process according to claim 3, wherein an organic peroxide in an amount of 0.0001 to 0.5 part by weight per 100 parts by weight of the polyolefin resin (A) is added in addition to the phosphorous type antioxidant compound (C), the anti-oxidant compound (B), and the polyolefin resin (A).
